(19) United States
(12) Patent Application Publication
(10) Pub. No.: US 2004/0038796 A1
(43) Pub. Date: Feb. 26, 2004

(54) Folder

(75) Inventors: Mitsuo Kitai, Kanagawa-ken (JP); Masafusa Takeda, Kanagawa-ken (JP); Kazuaki Shibuya, Tokyo (JP); Takanobu Sakakura, Tokyo (JP)

Correspondence Address: FOLEY AND LARDNER, SUITE 500, 3000 K STREET NW, WASHINGTON, DC, 20007, US

(73) Assignee: Kabushiki Kaisha Tokyo Kikai Seisakusho

(21) Appl. No.: 10/446,721

(22) Filed: May 29, 2003

(30) Foreign Application Priority Data
Aug. 20, 2002 (JP) 2002-238833

(51) Int. Cl. B31F 1/00

(52) U.S. Cl. 493/432

(57) ABSTRACT

Problems exist such as the presence of a narrow gap when the vicinity of a spliced joint of paper webs is passed between an outer surface of a roller and an outer surface of a folding cylinder. Paper blockages due to increased thickness are therefore likely to arise, making it easy for the paper web to become torn. This in turn damages the paper, and machine stoppages are also increased.

A folder FD of this invention is provided with a rotating roller 1 for wrapping paper webs W fed from upstream around a side facing a folding cylinder 3 to guide the webs to the folding cylinder 3 outer surface, provided close to a position where a plurality of pins 31 provided at appropriate places in an axial direction of the folding cylinder 3 pierce fed paper webs W, further upstream than a paper web W cutting position between the folding cylinder 3 and a cutting cylinder 4, parallel to the axis of the folding cylinder 3, wherein an outer part of the roller 1 is formed from a cushion member 11 capable of absorbing variations in a thickness direction of paper webs W fed from an upstream side.

### BACKGROUND OF THE INVENTION

1. Field of the Invention

This invention relates to a folder for feeding superposed paper webs between a folding cylinder and a cutting cylinder, holding by piercing with pins provided on the folding cylinder, wrapping around the outer surface of the folding cylinder and cutting a predetermined length, and folding parallel to the axis of the folding cylinder.

In detail, a roller capable of rotation is provided close to an outer surface of a folding roller for feeding a paper web, the paper web is fed towards the folding cylinder outer surface with the rear side supported so that piercing of pins into the superposed paper web is carried effectively, grooves are provided in a circumference direction on the outer surface of the roller, and in order to hold the paper web on the front surface of the folding cylinder, pins of the folding cylinder pierce through the paper web and the pierced pin fit into the grooves.

2. Description of the Related Art

Conventionally, a folder feeds a superposed paper web between a folding cylinder and a cutting cylinder, the web is held by piercing with pins provided on the folding roller, wrapped around the outer surface of the folding cylinder and cut to a predetermined length, and also folded parallel to the axis of the folding cylinder. For this type of folder, a device provided with a roller close to a position where pins provided on a folding cylinder pierce a paper web to be fed is disclosed in the entire specification of Japanese Utility Model Laid-open No. Sho. 62-157864 (related art 1) and Japanese Patent Laid-open No. Hei. 10-236726 (related art 2).

Related art 1 relates to a “folding machine”, and discloses a “folding machine characterized by a backup roller for receiving insertion pressure of pins added to a folding cylinder between the folding cylinder and a nipping roller, in such a manner that it can be freely contacted or separated.”Also disclosed in related art 1 is “A plurality of escape grooves 17 for pins 6 formed on a folding cylinder being machined on the outer surface of the backup roller 10 in a circumferential direction.” Also with this example, since a roller is caused to rotate only by frictional force of the paper, attempts have been made to reduce weight by making dimensions such as the roller diameter and roller thickness the minimum necessary, and machining is carried out so that there is no variation in thickness”.

Related art 2 relates to a “folder” and discloses “a rotating support surface 6 correspondingly arranged with a folding cylinder 1.1 for guiding a folding block in an inner part of a delivery region 19, and the support surface 6 supports a web 4 while being punctured using a holding element 3.”, and also discloses that “the rotating support surface is provided with peripheral grooves arranged apart from each other” and “provided so that peripheral grooves of the rotating support surface are positioned in alignment with the holding element”.

The folders shown in related art 1 and related art 2 are provided with a roller (backup roller 10, rotating support surface 6) for guiding superposed paper webs that have been fed from upstream to an outer surface of a folding cylinder, and also a folding roller and cutting roller for cutting and folding the paper webs fed from the roller. The roller is provided at a position where paper webs are wrapped around the outer surface of the folding cylinder further upstream than a web cutting position between the folding cylinder and the cutting cylinder that rotate in mutually opposite directions, and pins provided on the folding cylinder are provided close to a position for piercing the fed paper webs in such a manner as to be parallel to the axis of the folding cylinder and capable of rotation. There are then grooves provided in a circumferential direction at positions relative to the pins of the folding cylinder, on the outer surface of the roller.

Also, a plurality of pins are provided on the folding cylinder in a paper width direction that pierce the paper webs in the thickness direction, holding the paper webs to guide them in a rotating direction of the folding cylinder, and a blade is also provided for extracting the paper webs towards folding means in order to fold paper webs between the folding cylinder and the cutting cylinder parallel to the axis of the folding cylinder. A cutting knife for cutting the paper webs to a predetermined length between the cutting cylinder and the folding cylinder is provided on the cutting cylinder.

Paper webs superposed and introduced into the folder are first of all fed to the roller. In detail, paper webs fed from upstream are wrapped around the outer surface of the roller at a side facing the folding cylinder, and by causing the roller to rotate at the same speed as the paper webs they are guided to the outer surface of the folding cylinder. At this time, pins provided on the folding cylinder project further than the outer surface of the folding cylinder at a suitable rotational position of the folding cylinder, pierce through the superposed paper webs, and approach grooves of the roller. In this manner, the pins reliably penetrate a thickness direction of the paper webs fed in a superposed manner to the outer surface of the folding cylinder, and the paper webs are held on the folding cylinder outer surface.

The paper webs are wrapped around the folding cylinder by rotating the folding cylinder while holding with the pins of the folding cylinder, and at a cutting position between the folding cylinder and the cutting cylinder the paper webs are cut at a position close to a downstream side of the penetrating pins. After cutting, the paper webs in a state of being held on the outer surface of the folding cylinder by the pins are wrapped further around the folding cylinder by rotation of the folding cylinder, and when the leading end of the paper webs has reached an appropriate position in a rotational direction of the folding cylinder, the next cut is performed at the upstream side of the paper webs. Paper that has been cut to a specified length has a central part of a leading edge and a trailing edge that was cut next folded parallel to the axis of the folding cylinder by folding means, giving a folded printed article, which is then carried out of the machine. This type of cutting and folding of the paper webs is repeated.

As disclosed in related art 1 and related art 2, in order to hold superposed paper webs wrapped around the folding cylinder outer surface on the folding cylinder outer surface, pins projecting from the folding cylinder outer surface are pressed into and pierce through the paper webs between the roller outer surface and the penetrating pins approach grooves provided on the roller outer surface, which means that it becomes possible for the pins to sufficiently penetrate in a thickness direction of the paper webs to reliably hold the paper webs, and it is possible to stably cut the paper webs using a cutting knife at a cutting position between the folding cylinder and the cutting cylinder.

With the devices disclosed in the related art, the roller has a roller outer surface attached close to the folding cylinder outer surface, and a gap between the folding surface outer cylinder and the roller outer surface for feeding paper webs to the folding cylinder outer surface becomes narrow.

Also, for paper webs fed to the roller, a new paper web is made into a paper joint flap and fed before completion of consumption of a paper web being drawn out and initially consumed. At the time of this paper splicing, with respect to a joint between a paper web being drawn out and initially consumed and the leading edge of a new paper joint, since the paper web being drawn out and initially consumed has a trailing section cut at a slightly upstream side of the connecting section, paper from the connecting section to a cutting position, namely paper at an upstream side of the joint, passes between the roller outer surface and the folding cylinder outer surface in state where it has not been supported and in an unstable stream shape. Then, with this paper at an upstream side of this unstable paper web joint, the paper web thickness is not only twice as thick, but in there are sometimes cases where superposed paper becomes irregularly creased and passed through, and cases where the paper thickness becomes relatively thick and is passed through. It therefore becomes easy for paper webs to get jammed between the roller outer surface and the folding cylinder outer surface having a narrow gap, and this paper jamming causes tears in the paper web. Breakages arise because of the torn paper, and machine stoppages also increase. Also, deformation and damage to pins and thin members of the folding cylinder surface are attributable to paper blockages.

### SUMMARY OF THE INVENTION

The present invention has been conceived to solve the problems of the related art described above, and the object of the invention is to prevent machine stoppage due to torn paper and to prevent deformation or damage to pins of a folding cylinder and surface members by reliably passing a joint at the time of splicing a paper web in the related art to do away with paper blockages.

In order to achieve the above described object, a first aspect of the present invention is directed to a folder, for feeding superposed paper webs between a folding cylinder and a cutting cylinder, holding the paper webs with pins provided on the folding cylinder, wrapping around the folding cylinder outer surface, cutting to a predetermined length and then folding the cut of paper parallel to the axis of the folding cylinder, and having a roller, capable of rotation for wrapping paper webs fed from upstream around a side facing to the folding cylinder to guide the webs to the folding cylinder outer surface, provided close to a position where a plurality of pins provided at appropriate places in an axial direction of the folding cylinder pierce fed paper webs, further upstream than a paper web cutting position between the folding cylinder and the cutting cylinder, parallel to the axis of the folding cylinder, wherein an outer part of the roller being formed from a cushion member capable of absorbing variations in a thickness direction of paper webs fed from an upstream side.

A second aspect of the present invention is directed to a folder having a plurality of grooves provided on the roller outer surface at positions facing pins of the folding cylinder of the folder, with pins that have penetrated the paper webs being capable of fitting into the grooves.

A third aspect of the present invention is directed to a folding machine of either of the first or second aspect, wherein the cushion member comprises a continuous foam member or a brush type member.

A fourth aspect of the present invention is directed to a folding machine of the second aspect, wherein the cushion member is made of an elastic sealed body filled with fluid.

### BRIEF DESCRIPTION OF THE DRAWINGS

FIG. 1 is a schematic drawing showing an example of the present invention, and shows a state where pins penetrate paper webs in a folding machine.

FIG. 2 is a cross sectional schematic drawing taken along line A-A in FIG. 1.

FIG. 3 is a schematic drawing showing a state where paper webs are being cut in a folding machine.

FIG. 4 is a schematic drawing showing a state where a joint section passes at the time of splicing paper webs, in a folding machine.

### DETAILED DESCRIPTION OF THE PREFERRED EMBODIMENT

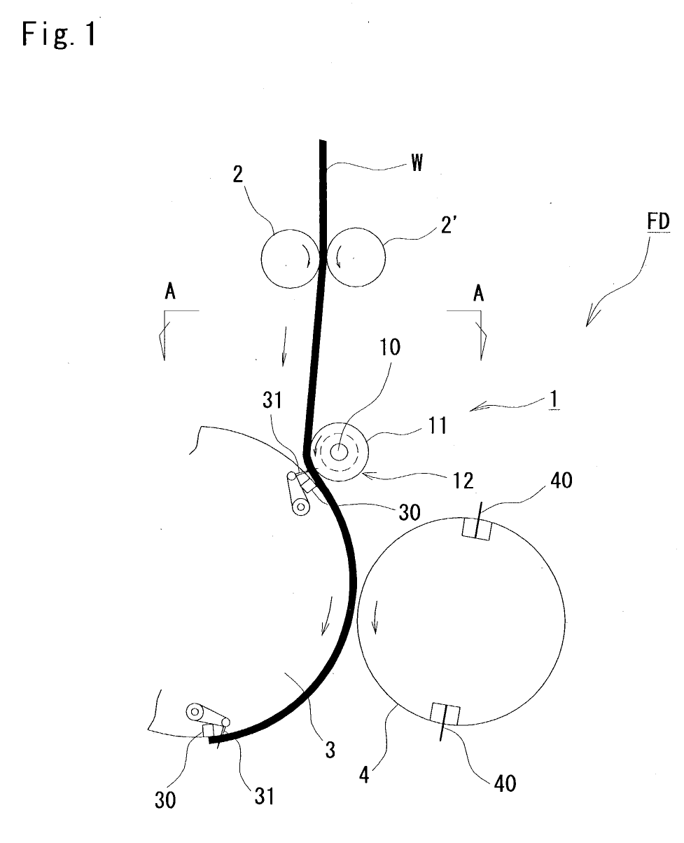

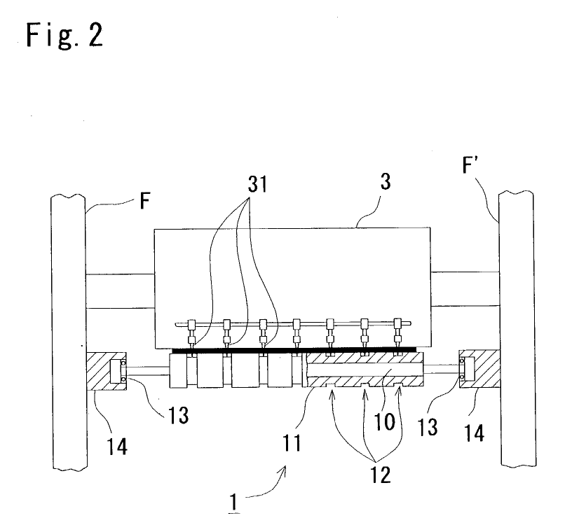

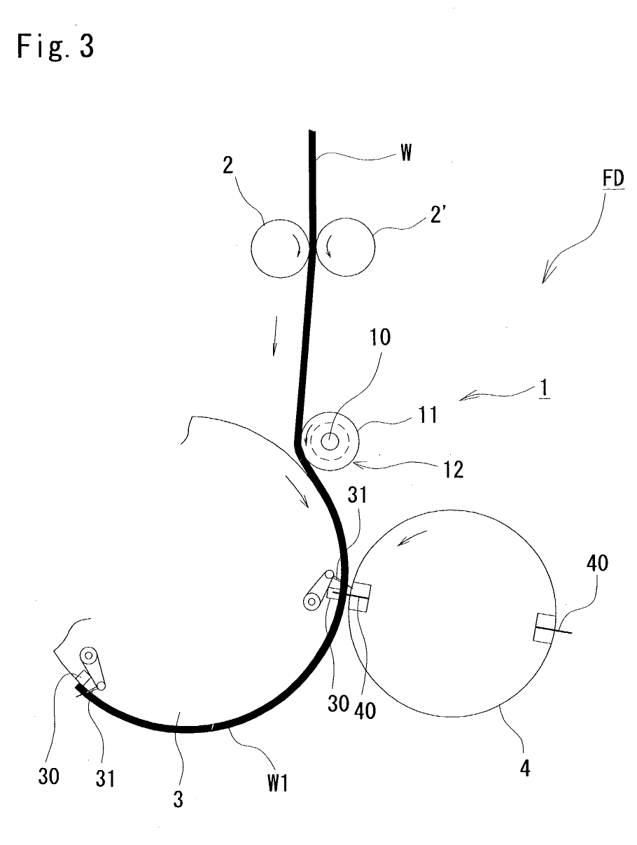

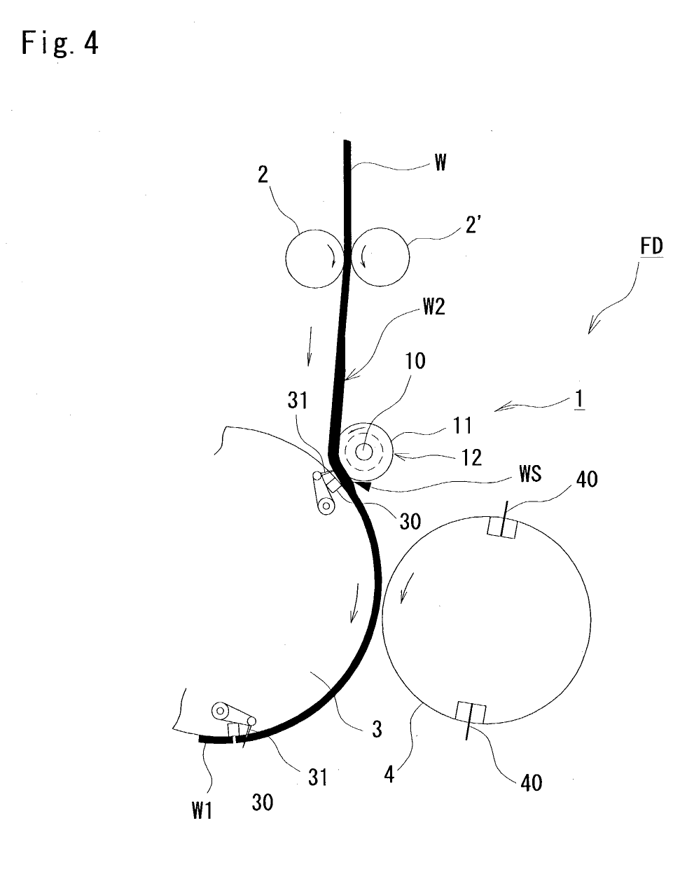

The present invention will now be described based on FIG. 1, which is a schematic drawing showing an example of the present invention, and shows a state where pins penetrate paper webs in a folding machine, FIG. 2, which is a cross sectional schematic drawing taken along line A-A in FIG. 1, FIG. 3, which is a schematic drawing showing a state where paper webs are being cut in a folding machine, and FIG. 4, which is a schematic drawing showing a state where a joint section passes at the time of splicing paper webs in a folding machine, and which all show embodiments of the present invention.

Although not shown in the drawings, at least one paper feeder and printer are provided on respective rotary presses, and a folder FD comprising a pin receiving roller 1, nipping rollers 2, 2′, a folding cylinder 3 and a cutting cylinder 4, are deployed downstream, as shown in FIG. 1.

Paper webs W pulled out from a paper roll loaded in each paper feeder are printed in each printer, then fed to the folder FD, cut to a specified length and then folded to produce a printed article.

A description will by given of the folder FD representing an embodiment of the present invention, based on FIG. 1 and FIG. 2. Nipping rollers 2, 2′ are constituted by a pair of drive rollers rotating in mutually opposite directions, and guide superposed paper webs W, introduced to the folder FD from the upstream paper feeders and printers, towards the pin receiving roller 1 at a downstream side.

The pin receiving roller 1 is supported parallel to the axis of the folding cylinder 3 and capable of rotation, and the position it is located at is upstream in a traveling direction of the paper webs W from a paper web cutting position between the folding cylinder 3 and the cutting cylinder 4, and close to a position where pins 31 provided on the folding cylinder 3 pierce the paper webs W. The pin receiving roller 1 has a shaft 10, a cushion member 11 and grooves 12, and the shaft 10 is rotatably supported at both ends in brackets 14 via bearings 13. Two brackets 14 are respectively attached to frames F and F′ supporting the folder FD from both sides.

The cushion member 11 is provided on the outer surface of the rotatable shaft 10 with its center aligned with the axial center of the shaft 10, and has the property of being able to absorb external force by deforming in response to external force. The cushion member 11 is comprised of a material capable of absorbing variations in the thickness direction of the paper webs W fed from upstream. The cushion member 11 may be an elastic sealed body filed with fluid (such as gas), brushes arranged on the outer surface of the shaft 10, or a continuous foam material.

The grooves 12 are provided extending in a circumferential direction of the pin receiving roller 1 and extending around its entire surface, and a plurality of grooves 12 are provided at positions on the outer surface of the pin receiving roller 1 facing a plurality of pins 31 appropriately provided in an axial direction of the folding cylinder 3. In this embodiment, the grooves 12 have a depth that is shallower than the extent of the thickness of the cushion member 11, and are only formed by the cushion member 11, but as other embodiments, the groove bottom can also be formed using the surfaces of the shaft 10, or by including the shaft 10 in the grove side surfaces.

The folding cylinder 3 and the cutting cylinder 4 rotate in mutually opposite directions at a downstream side in the direction of travel of the paper webs W of the pin receiving roller 1.

The folding cylinder 3 comprises a cutting knife receiving section 30 for receiving a cutting knife 40 of the cutting cylinder 4 for cutting paper webs W fed between the cutting cylinder 4 and the folding cylinder 3, a plurality of pins 31 provided in an axial direction of the folding cylinder, and blade (not shown) for pushing a substantially central part of cut-off webs W1 towards folding means, not shown, in order to fold the cut-off web W1, that has been cut to a specified length between the cutting cylinder 4 and the folding cylinder 3, parallel to the axis of the folding cylinder 3. The pins 31 penetrate and hold the fed paper webs W in a thickness direction, and the paper webs W are guided in a rotational direction of the folding cylinder 3 held as they are and wrapped around the outer surface of the folding cylinder 3. With this embodiment, the cutting knife receiving section 30, pins 31 and blade are provided at three places equally divided around the circumference of the folding cylinder 3.

The cutting cylinder 4 is provided with a cutting knife 40 arranged in a widthwise direction of the paper webs, and being longer than the width of the paper webs, in order to cut paper webs W between the cutting cylinder 4 and the folding cylinder 3 to a predetermined length. With this embodiment, a cutting knife 40 is provided at 2 places equally divided around the circumference of the cutting cylinder 4.

Next, operation of the folder FD of the embodiment of the present invention will be described based on FIG. 1 to FIG. 4. If the folder FD is operated, the folding cylinder 3 and the cutting cylinder 4 rotate in synchronism. Paper webs W that have passed from an upstream side paper feeder through a printer, been printed and superposed are then introduced into the folder FD. The paper webs W that have been introduced into the folder FD are initially introduced between the nipping rollers 2, 2′, then fed to the downstream side pin receiving roller 1 by rotational drive of the nipping rollers 2, 2′. The paper webs W fed by the nipping rollers 2, 2′, in detail, are wrapped around the outer surface of the pin receiving roller I at a side facing the folding cylinder 3, and by bringing the pin receiving roller 1 into contact with the paper webs W the pin receiving roller 1 is caused to rotate at substantially the same speed as the traveling speed of the paper webs W. The paper webs W are guided and fed from the outer surface of the pin receiving roller 1 to the outer surface of the folding cylinder 3.

The paper webs W are wrapped around the outer surface of the pin receiving roller 1, and together with this the pins 31 provided on the folding cylinder 3 are made to project further out than the outer surface at suitable rotational positions of the folding cylinder 3. The projecting pins 31 pierce and penetrate the superposed paper webs W for travel between the folding cylinder 3 and the pin receiving roller 1. Tips of the penetrated pins 31 approach the grooves 12 of the pin receiving roller 1. The pins 31 penetrate reliably in a thickness direction of the paper webs W fed to the outer surface of the folding cylinder 3, thus holding the paper webs W on the outer surface of the folding cylinder 3.

Next, as shown in FIG. 3, the paper webs W are wrapped around the folding cylinder 3 accompanying rotation of the folding cylinder 3 while being held by penetration of the plurality of pins 31 provided in a paper width direction of the folding cylinder 3, and at the cutting position, being between the folding cylinder 3 and the cutting cylinder 4, the webs are cut at positions close to a downstream side of the penetrating pins 31 by bringing the cutting knife 40 of the cutting cylinder 4 into engagement with the cutting knife receiving section 30, and a fragment of the downstream leading end is removed.

Upstream paper webs W that have been cut are held in place by penetration of the leading edge by the pins 31 and wrapped around the folding cylinder 3 in accordance with rotation of the folding cylinder 3, and if the folding cylinder 3 is rotated to an appropriate position the pins 31 are made to project further than the outer surface of the folding cylinder 3, as described above, to pierce and penetrate superposed paper webs W for travel between the pin receiving roller 1 and the folding cylinder 3, and tips of the penetrated pins 31 approach the grooves 12 of the pin receiving roller 1. The paper webs W held by the pins 31 are wrapped around the folding cylinder 3 by rotation of the folding cylinder 3, and cut into a leading edge of the upstream paper webs W and cut-off paper webs W1 at positions close to a downstream side of the penetrating pins 31 being between the folding cylinder 3 and the cutting cylinder 4 bringing the cutting knife 40 of the cutting cylinder 4 into engagement with the cutting knife receiving section 30, and the cut-off paper webs W1 are disconnected, and the formed cut-off paper webs W1 are cut-off and separated from the paper webs W at a specified length.

Next, a central part of the cut-off web W1 between a leading edge and a trailing edge that was cut off next is folded parallel to the axis of the folding cylinder 3 by causing an intermediate part facing folding means to be pressed outwards by a blade of the folding cylinder 3, and the cut-off web W1 then constitutes a two folded printed article and is conveyed out of the machine. The above described operation, namely penetration and holding of the paper webs W using the pins 31 of the folding cylinder 3, formation of the cut-off web W1 by cutting the paper webs W using the cutting knife 40 and the cutting knife receiving section 30, and the folding by pushing out the intermediate part of the cut-off web W1 using the blade, are sequentially and continuously repeated.

Also, at the time of splicing paper webs W continuously supplied from the roll of paper provided in the paper feeder of the rotary press, a tip end of a new paper roll is connected to the old paper roll, the old paper roll is cut at an upstream position of the connecting position, and a spliced paper web W passes from the paper feeder to the printer and is then guided to the folder FD in a state where there is unstable streaming in a state where the trailing end of the old paper roll is not supported. Not only does this spliced paper web W have a thickness of twice the paper web W at the seam WS, but a streaming portion W2 upstream of the seam WS (made an overlapping portion in the following) constitutes creased paper superposed in an irregular manner and reaches the folder FD.

The spliced paper web W is fed between the nipping rollers 2, 2′ in the folder FD, and then fed to the pin receiving roller 1 by rotation of the nipping rollers 2, 2′.

The paper webs W fed by the nipping rollers 2, 2′ are, in detail, wrapped around the outer surface of the pin receiving roller 1 at a side facing the folding cylinder 3, and as a result of contacting the paper webs W, the pin receiving roller 1 is caused to rotate at substantially the same speed as the speed of travel of the paper webs W. The paper webs W are guided and fed from the pin receiving roller 1 to the outer surface of the folding cylinder 3.

Since the pin receiving roller 1 is provided so that a gap with respect to the folding cylinder 3 becomes narrow, when the pins 31 pierce and penetrate the fed paper webs W, the tips of the penetrated pins 31 approach the grooves 12. Also, when the seam WS of a paper web W passes through between the pin receiving roller 1 and the folding cylinder 3, in response to a state where the seam WS and the overlapped section W2 upstream of the seam WS become twice or more as thick as the paper webs W before and after that section, the cushion member 11 provided on the outer surface of the pin receiving roller 1 flexes in the direction of the shaft 10 of the pin receiving roller 1 to absorb the increased thickness of the seam WS and the overlapped section W2, and it is possible to guide the seam WS and the overlapped section W2 to the outer surface of the folding cylinder 3. Accordingly, the seam WS and the overlapped section W2 upstream of the seam WS at the time of splicing the paper webs W are guided to the outer surface of the folding cylinder 3 without getting jammed between the pin receiving roller 1 and the folding cylinder 3.

Also, even in the event that the seam WS of the paper webs W or the overlapped section W2 upstream of the seam WS are pierced by one projecting pin 31 of the folding cylinder 3 and passed through, it is possible to absorb the increased thickness of the seam and the overlapped section W2 upstream of the seam using the operation of the cushion member 11 of the pin receiving roller 1. Further, since the pins 31 have pierced the seam WS or the overlapped section W2 upstream of the seam so that it is possible to cause the tips of the pins 31 to approach the grooves 12 of the pin receiving roller 1, it becomes possible to reliably hold the seam WS of the paper webs W and the overlapped section W2 upstream of the seam on the outer surface of the folding cylinder 3 using the pins 3 1.

Next, cutting the paper webs W using the cutting knife 40 of the cutting cylinder 4 and the cutting knife receiving section 30 of the folding cylinder 3, forming a cut-off web W1, folding by pushing out an intermediate portion of the cut-off web W1 using a blade, and conveying a folded printed article out of the machine is the same as described above.

The cushion member 11 is formed of a material that can absorb variations in the thickness direction of the paper webs W fed from upstream, and with this embodiment is made of layers made of an elastic sealed body filled with fluid (such as a gas) and a continuous foam material, with groves 12 being formed in the cushion member 11 at positions facing the pins 31 of the folding cylinder 3. Also, in the case of a cushion member 11 formed from a continuous foam material, it is possible to use without providing the grooves 12.

A description will now be given of brushes provided around the outer surface of the shaft 10, as another embodiment of the cushion member 11 of the present invention. When the cushion member 11 is formed from brushes provided on the outer surface of the shaft 10, it is possible to absorb increased thickness of the seam WS and the overlapped section W2 upstream of the seam using bending of the brushes, and also, even in the case where the pins 31 of the folding cylinder 3 penetrate the paper webs W, the seam WS and the overlapped section W2 upstream of the seam, since the tips of the pins 31 can fit into any part of the brushes, it is not necessary to provide grooves 12 at positions facing the pins 31 of the folding cylinder 3.

Still further, the pin receiving roller 1 of this embodiment is provided capable of being carried along with and rotating at substantially the same speed as the paper webs W to travel using the fed paper webs W. With another embodiment of the pin receiving roller 1 of the present invention, the pin receiving roller 1 itself is provided so as to be capable of rotational drive, and as well as causing rotation that matches the traveling speed of the fed paper webs W, it is also possible to provide the pin receiving roller 1 so that it has a function of feeding the paper webs W to the outer surface of the folding cylinder 3.

With the present invention, by providing a cushion member at an outer surface side of a pin receiving roller, it is possible to prevent paper blockages between a folding cylinder and the pin receiving roller when splicing paper webs. It is also possible to prevent lowering of printing efficiency due to damaged paper or machine stoppage attributable to torn paper by preventing paper blockage, and it is also possible to prevent deformation or damage to pins of the folding cylinder and folding cylinder surface members due to paper blockage.

What is claimed is:

1. A folder, for feeding superposed paper webs between a folding cylinder and a cutting cylinder, holding the paper webs with pins provided on the folding cylinder, wrapping the paper webs around the folding cylinder, cutting to a predetermined length and then folding a product parallel to an axis of the folding cylinder, and having a roller, capable of rotation for wrapping the paper webs fed from upstream around a side facing the folding cylinder to guide the paper webs to the folding cylinder outer surface, provided close to a position where a plurality of pins provided at appropriate places in an axial direction of the folding cylinder hold paper webs, further upstream than a paper web cutting position between the folding cylinder and the cutting cylinder, parallel to the axis of the folding cylinder, wherein
an outer part of the roller is formed from a cushion member capable of absorbing variations in a thickness direction of the paper webs fed from an upstream side.

2. The folder of claim 1, wherein the roller is provided with a plurality of grooves provided in an axial direction on the roller outer surface at positions facing pins of the folding cylinder, and spreading circumferentially around the roller, with pins that hold the paper webs being capable of fitting into the grooves.

3. The folder of claim 1, wherein the cushion member is formed from a continuous foam member.

4. The folder of claim 2, wherein the cushion member is formed from a continuous foam member.

5. The folder of claim 1, wherein the cushion member is formed from a brush member.

6. The folder of claim 2, wherein the cushion member is formed from a brush member.

7. The folder of claim 2, wherein the cushion member is formed from a sealed elastic body filled with fluid.

8. The folding machine of claim 7, wherein the fluid of the sealed elastic body is a gas.
